(19) United States
(12) Patent Application Publication
(10) Pub. No.: US 2013/0134027 A1
(43) Pub. Date: May 30, 2013

(54) PUSH SWITCH

(71) Applicants: Seigo Ohtaka, Tokyo (JP); Shigemi Kawaguchi, Tokyo (JP)

(72) Inventors: Seigo Ohtaka, Tokyo (JP); Shigemi Kawaguchi, Tokyo (JP)

(21) Appl. No.: 13/677,531

(22) Filed: Nov. 15, 2012

(30) Foreign Application Priority Data
Nov. 25, 2011 (JP) 2011-256999

(51) Int. Cl. H01H 13/14

(52) U.S. Cl. CPC H01H 13/14
USPC 200/531

(57) ABSTRACT

There is provided a push switch including an insulating case, a conductive member, a movable electrode and an operating member. The insulating case has a wall portion defining a recess. The conductive member has a first portion embedded into the wall portion and a second portion disposed in the recess as a fixed electrode. The movable electrode is disposed in the recess and is displaced between a first position and a second position. The operating member is moved to displace the movable electrode from the second position to the first position. An anchor member protrudes from the conductive member in a direction not parallel to the direction in which the operating member is moved, and embedded into the wall portion.

### BACKGROUND

The invention relates to a switch used in various small electronic equipment, and more particularly, to a push switch which is mounted on a circuit board and includes an operating member adapted to be displaced in a direction parallel to the circuit board.

In such push switches, a resin case mounted on a circuit board has a recess formed therein. A conductive member is integrally provided in the case by insert molding and the like, and a part of the conductive member is disposed as a fixed electrode inside the recess. A movable electrode is additionally disposed inside the recess to be elastically displaced between a first position in which the moveable electrode is contacted with the fixed electrode and a second position in which the movable electrode is spaced apart from the fixed electrode.

The push switches are provided with an operating member. When a user presses the operating member in a state in which the switch is mounted on the circuit board, the operating member is moved in a direction parallel to the circuit board so that the movable electrode is displaced to the first position, and thus is electrically conductively connected with the fixed electrode. If the pressing force is removed, the moveable electrode is elastically returned to the second position, thereby canceling the electrically conductive state between the movable electrode and the fixed electrode (e.g., see Patent Document 1).

[Patent Document 1] Japanese Patent No. 4557043

In switches as described above, the pressing force exerted to move the operating member in the direction parallel to the circuit board, causes a component force in a direction parallel to the circuit board and a component force in a direction away from the circuit board, thereby acting to detach a part of the case from the conductive member. As the switches are downsized accompanying with downsizing in recent electronic equipment, the pressing force exerted by a user becomes higher relative to the structural strength of the switches. If the pressing force exceeds the structural strength of the switches, a part of the case is often broken and detached from the conductive member.

### SUMMARY

It is therefore one advantageous aspect of the present invention to provide thin connector a push switch which can satisfy demands for downsizing and also enhance durability against a pressing force of an operating member.

According to one aspect of the invention, there is provided a push switch configured to be mounted on a circuit board, comprising:

an insulating case, having a wall portion defining a recess;

a conductive member, having a first portion embedded into the wall portion and a second portion disposed in the recess as a fixed electrode;

a movable electrode, disposed in the recess, and configured to be displaced between a first position in which the moveable electrode is contacted with the fixed electrode and a second position in which the movable electrode is spaced apart from the fixed electrode;

an operating member, configured to be moved in a direction parallel to the circuit board by a pressing force exerted thereon in a state in which the push switch is mounted on the circuit board, and to displace the movable electrode from the second position to the first position; and

an anchor member, protruding from the conductive member in a direction not parallel to the direction in which the operating member is moved, and embedded into the wall portion.

The anchor member may include a first anchor portion having a first width dimension and a second anchor portion having a second width dimension greater than the first width dimension.

The first anchor portion may be located closer to the conductive member than the second anchor portion is.

The anchor member may form an integral structure with the first portion.

The anchor member may protrude from a side edge of the first portion.

The anchor member may form an integral structure with the second portion.

The anchor member may protrude from a side edge of the second portion.

The anchor member may be provided on a section of the conductive member extended parallel to the circuit board in a state where the push switch is mounted on the circuit board.

The conductive member may comprise a third portion exposed on a side surface of the case.

The conductive member may comprise a third portion exposed on a surface of the case facing the circuit board.

### BRIEF DESCRIPTION OF DRAWINGS

FIG. 1 is a perspective view showing the exterior of a push switch according to an embodiment of the present invention.

FIG. 2A is a top view showing the exterior switch of FIG. 1.

FIG. 2B is a front view showing the exterior of the push switch of FIG. 1.

FIG. 2C is a bottom view showing the exterior of the push switch of FIG. 1.

FIG. 2D is a rear view showing the exterior of the push switch of FIG. 1.

FIG. 2E is a right side view showing the exterior of the push switch of FIG. 1.

FIG. 3 is an exploded perspective view showing the internal configuration of the push switch of the FIG. 1.

FIG. 4A is a perspective view showing a shape of conductive members in the push switch of the FIG. 1, and FIG. 4B is a sectional view taken along a line IV-IV in FIG. 1.

FIG. 5A shows the shape of an anchor member.

FIG. 5B is an alternative shape showing stepped side and end surfaces.

FIG. 5C shows the anchor of being wider in width.

FIG. 5D shows the anchor being narrower in width.

FIG. 6 is a perspective view showing the exterior of a variant of the push switch of FIG. 1.

### DETAILED DESCRIPTION OF EXEMPLIFIED EMBODIMENTS

Embodiments according to the present invention will be now described in detail with reference to the accompanying drawings. In the drawings referred in the following description, the scale of each element is appropriately adjusted to easily recognize the size of each element.

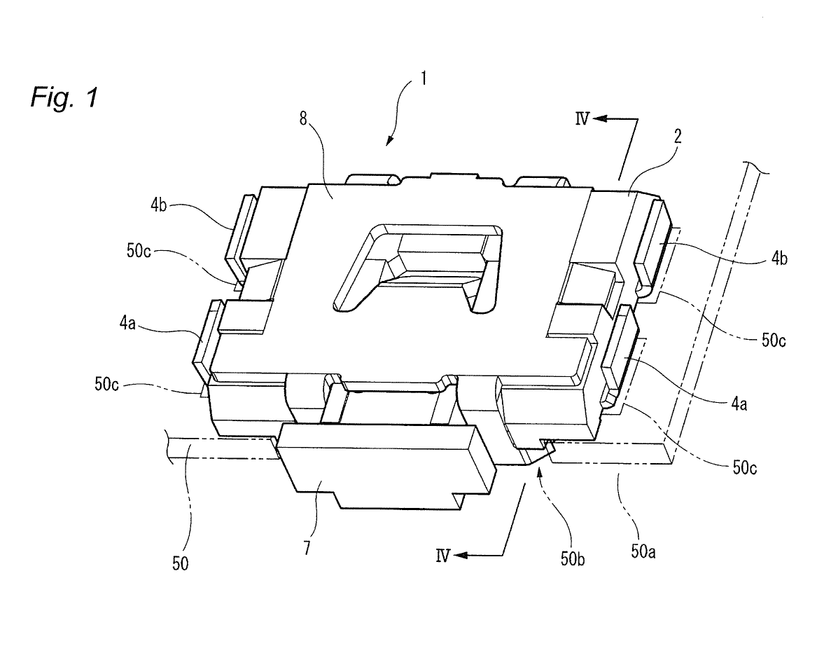

FIG. 1 is a perspective view showing the exterior of a push switch 1 according to an embodiment of the present invention. The push switch 1 includes a case 2 mounted on a circuit board 50. A cover 8 is installed on a top side of the case 2 and an operating member 7 is provided on a front side of the case 2. The operating member 7 is configured to be displaced in a front-rear direction in response to a pressing operation by a user.

A first outer connecting terminal 4a and a second outer connecting terminal 4b are provided on each of left and right sides of the case 2. Each of the first outer connecting terminal 4a and the second outer connecting terminal 4b is connected and fixed to a respective land portion 50c of a wiring terminal formed on a mounting surface of the circuit board 50 by soldering. In the following description, the first outer connecting terminal 4a and the second outer connecting terminal 40b will be called collectively as the ‘outer connecting terminal,’ as necessary.

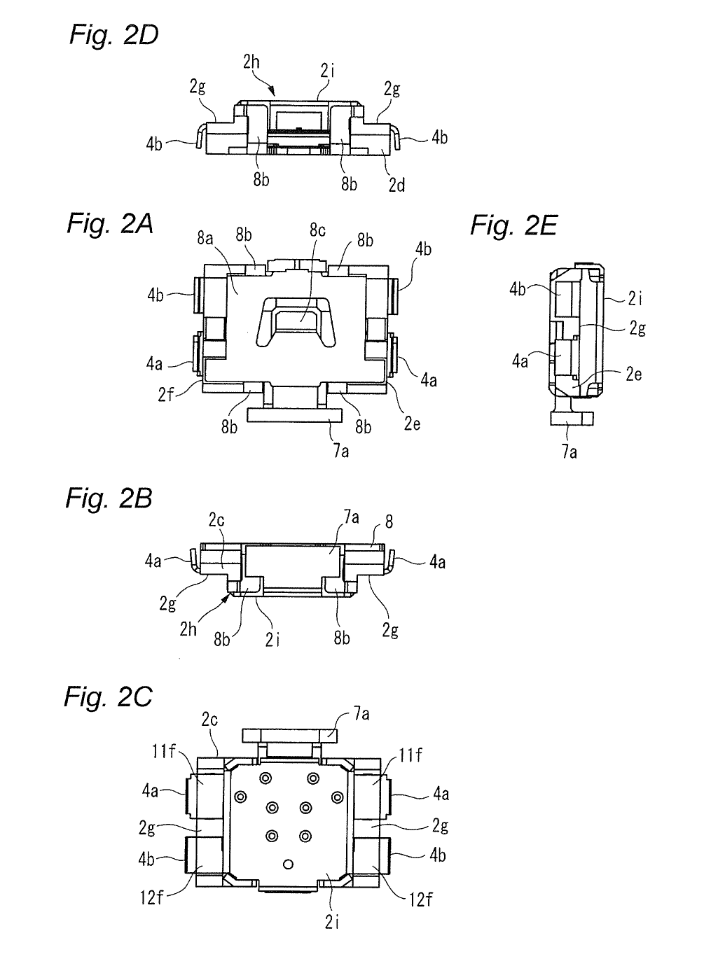

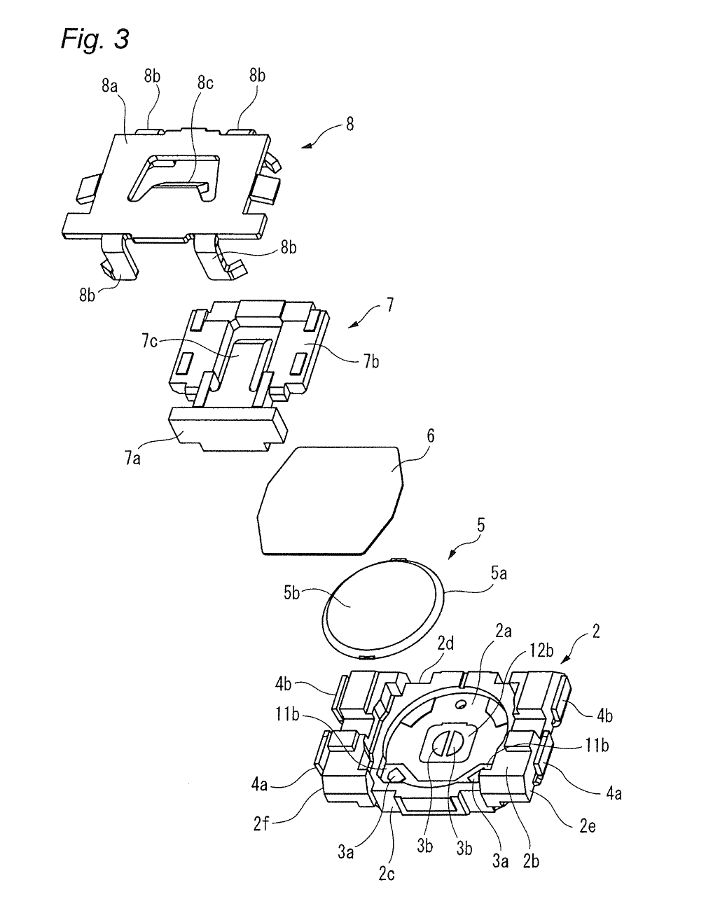

FIGS. 2A to 2E are five-side views showing the exterior of the push switch 1 of FIG. 1, and FIG. 3 is an exploded perspective view showing the internal configuration of the push switch 1. FIG. 2A is a top view, FIG. 2B is a front view, FIG. 2C is a bottom view, FIG. 2D is a rear view and FIG. 2E is a right side view. The shape when viewed from the left side is symmetric to that shown in the right side view, and accordingly the illustration thereof is omitted.

The case 2 is made of an insulating material, such as a resin, and has a recess 2a defined to be opened upward by a wall portion. A plurality of first fixed electrodes 3a are disposed on a perimeter edge of a bottom portion of the recess 2a and a plurality of second fixed electrodes 3b are disposed in the center of the bottom portion.

A movable electrode 5 is an elastically deformable and dome-shaped conductive member. The movable electrode 5 is received and disposed in the recess 2a such that an outer edge 5a thereof is contacted with the first fixed electrodes 3a and a central portion 5b is spaced from and opposed to the second fixed electrodes 3b. In other words, the movable electrode 5 takes a shape bulged upward in a normal state.

A protection member 6 made of an insulating resin sheet material, such as a polyamide resin is placed on a top surface 2b of the case 2 to cover the recess 2a and is fixed by an adhesive. The protection member 6 prevents foreign substances from invading into the recess 2a and also is interposed between an operating member 7, as described below, and the movable electrode 5, thereby performing as a cushioning material.

The operating member 7 is made of a resin material and the like and includes a pressing portion 7a, a supporting portion 7b, and an operating portion 7c. The operating member 7 is placed on the protection member 6.

A cover 8, which is formed by punching and bending a metal sheet, includes a main body 8a placed on the top surface 2b of the case 2 and four engaging legs 8b extending downward from front and rear edges of the main body 8a. A portion of the middle of the main body 8a is cut out to form a guide piece 8c obliquely downwardly extending rearward.

The engaging legs 8b are engaged at predetermined locations of a front surface 2c and a rear surface 2d of the case 2, so that the cover 8 is mounted on the case 2 and the supporting portion 7b and the operating portion 7c of the operating member 7 are held movably in a front-rear direction between the main body 8a of the cover 8 and the protection member 6. The pressing portion 7a of the operating member 7 is protruded forward relative to the front surface 2c of the case 2.

As shown in FIG. 2, left and right sides of a lower portion of the case 2 constitute board facing surfaces 2g. A region located between the board facing surfaces 2g constitutes a board inserting portion 2h protruding downward. As shown in FIG. 1, the board inserting portion 2h is inserted into a notch 50b formed in an end surface 50a of the circuit board 50 and a bottom surface 2i thereof is located at side of a lower surface of the circuit board 50.

In this state, the board facing surfaces 2g face an upper surface of the circuit board 50 with a slight gap interposed therebetween. Each of the first outer connecting terminal 4a and the second outer connecting terminal 4b faces the respective land portion 50c of the wiring terminal formed on the mounting surface of the circuit board 50 with a slight gap interposed therebetween. A solder is flowed into the gap, so that each of the first outer connecting terminal 4a and the second outer connecting terminal 4b is connected and fixed to the respective land portion 50c.

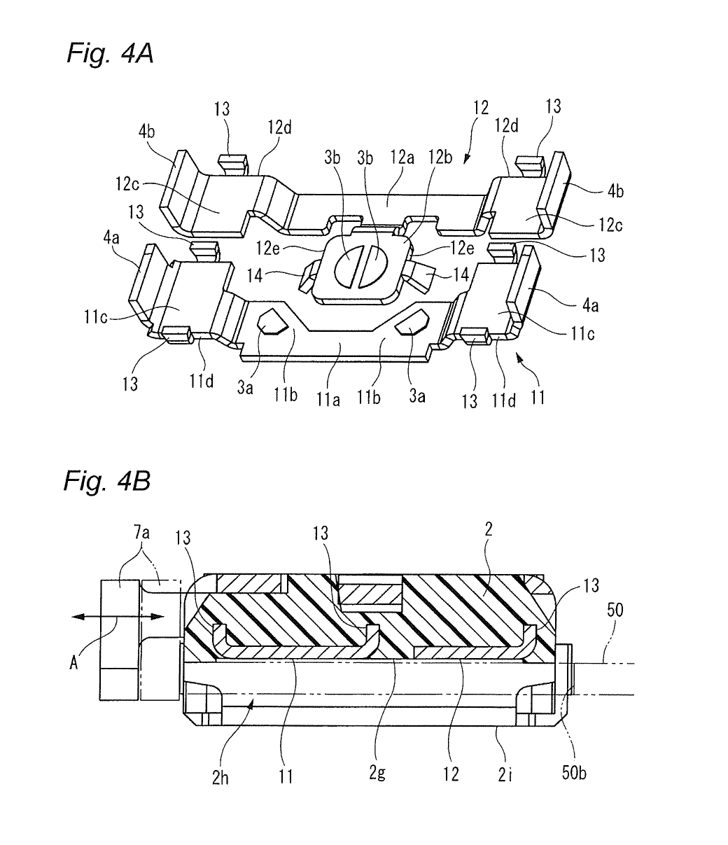

FIG. 4A is a perspective view showing the exterior of a first conductive member 11 and second conductive member 12 for forming an electrically conductive path of the push switch 1. In the following description, the first conductive member 11 and the second conductive member 12 will be called collectively as the ‘conductive member,’ as necessary.

The conductive members are formed by punching and bending a metal sheet and also integrally molded in the case 2 by insert molding and the like, so that a portion thereof is embedded into the case 2. Specifically, the conductive members include a first portion embedded into the wall portion defining the recess 2a of the case, and a second portion disposed inside the recess 2a of the case 2, and a third portion exposed to the outside of the case 2.

The first conductive member 11 extends in a left-right direction and the first fixed electrodes 3a are provided on both left and right sides of a central portion 11a thereof. Also, both left and right ends of the first conductive member 11 are bended upward to constitute the first outer connecting terminals 4a. As shown in FIG. 3, a portion 11b (an electrode forming portion 11b) in which the first fixed electrodes 3a are included, is disposed inside the recess 2a of the case 2, and the first outer connecting terminals 4a are exposed on left and right side surfaces 2e and 2f of the case 2 to the outside of the case 2. The electrode forming portion 11b corresponds to the second portion of the first conductive member 11, and the first outer connecting terminals 4a correspond to the third portion of the first conductive member 11. Besides these portions, a portion 11c is embedded into the wall portion defining the recess 2a. The embedded portion 11c corresponds to the first portion of the first conductive member 11. In other words, the first fixed electrodes 3a and the first outer connecting terminals 4a are electrically conductively connected with each other via the embedded portion 11c.

The second conductive member 12 is formed in a T-shape, and a front end 12b (an electrode forming portion 12b) of a section thereof extending forward relative to a central portion 12a of a section thereof extending in a left-right direction is provided with the second fixed electrodes 3b. Both ends of the section extending in a left-right direction are bended upward to constitute the second outer connecting terminals 4b.

As shown in FIG. 3, the portion 12b in which the first fixed electrodes 3b are included, is disposed inside the recess 2a of the case 2, and the second outer connecting terminals 4b are exposed on left and right side surfaces 2e and 2f of the case 2 to the outside of the case 2. The portion 12b corresponds to the second portion of the second conductive member 12, and the second outer connecting terminals 4b correspond to the third portion of the second conductive member 12. Besides these portions, a portion 12c is embedded into the wall portion defining the recess 2a. The embedded portion 12c corresponds to the first portion of the second conductive member 12. In other words, the second fixed electrodes 3b and the second outer connecting terminals 4b are electrically conductively connected with each other via the embedded portion 12c.

As shown in FIG. 4B, when a user indirectly or directly presses the pressing portion 7a of the operating member 7 rearward, the supporting portion 7b and the operating portion 7c are slid rearward beneath the cover 8. If the operating portion 7 is moved rearward by a predetermined amount, the operating portion 7 is abutted against a lower surface of the guide piece 8c of the cover 8. Because the guide piece 8c is obliquely downwardly inclined, the operating portion 7c of the operating member 7 is downwardly guided to press the movable electrode 5 via the protection member 6.

If a load exerted on the movable electrode 5 exceeds a predetermined value, the central portion 5b is inverted to become a downward convexed state while accompanying a clicking feel, and also contacted to the second fixed electrodes 3b. Therefore, the first fixed electrodes 3a and the second fixed electrodes 3b are electrically conductively connected with each other via the movable electrode 5. Accordingly, for each of the first fixed electrodes 3a and the second electrodes 3b, at least one electrode may be provided.

If the pressing force is removed, the central portion 5b is returned to an initial state (i.e., an upward convexed state) by a self-restoration force (elasticity) of the movable electrode 5 while accompanying a clicking feel, and the electrically conductive state between the first fixed electrodes 3a and the second fixed electrodes 3b is cancelled. The operating portion 7c of the operating member 7 is obliquely upwardly guided by the guide piece 8c of the cover 8, so that the supporting portion 7b is slid forward and the pressing portion 7a is returned to an initial position.

Specifically, the movable electrode 5 can be displaced between a first position in which the moveable electrode 5 is contacted with the second fixed electrodes 3b and a second position in which the movable electrode 5 is spaced apart from the second fixed electrodes 3b. The operating member 7 is moved in a direction parallel to the circuit board 50 by a pressing force exerted thereon from the outside in a state in which the push switch 1 is mounted on the circuit board 50, so that the movable electrode 5 is moved from the second position to the first position.

The operating force for pressing the operating member 7 causes a component force in a direction parallel to the circuit board 50 and a component force in a direction away from the circuit board 50, thereby acting to detach a part of the case 2 from the conductive members. Accordingly, the push switch 1 of the embodiment includes anchor members 13, as shown in FIG. 4B, which protrude from the conductive members in a direction not parallel to a moving direction A of the operating member 7 and are embedded into the wall portion defining the recess 2a of the case 2. The anchor members 13 can prevent a part of the case 2 from being detached from the conductive members, in particular by the component force in the direction parallel to the circuit board 50.

As shown in FIGS. 4A and 4B, the first conductive member 11 has a plurality of anchor members 13. Each of the anchor members 13 protrudes upward from a side edge 11d of the embedded portion 11c. Each of the anchor members 13 forms an integral structure with the embedded portion 11c, and thus, together with the first conductive member 11, is easily formed by punching and bending a metal sheet.

The second conductive member 12 also has a plurality of anchor members 13. Each of the anchor members 13 protrudes upward from a side edge 12d of the embedded portion 12c. Each of the anchor members 13 forms an integral structure with the embedded portion 12c, and thus, together with the second conductive member 12, is easily formed by punching and bending a metal sheet.

As used herein, the term ‘integral structure’ means that boundaries between the anchor members 13 and the embedded portions 11c and 12c are made of an identical material and are formed in a continuous state (i.e., a monolithic state). In the following description, the term is used to be distinguished from a configuration in which two or more members different in material or properties are integrally connected to each other by welding or bonding. Because the anchor members 13 and the embedded portions 11c and 12c are formed in the integral structure, a structure of a high strength can be obtained by an easy processing.

As each of the anchor members 13 is further extended upward, in other words, further spaced away from the embedded portions 11c and 12b, a width dimension of the anchor member 13 is increased. This can more effectively prevent a part of the case 2 from being detached from the conductive members, in particular by the component force in the direction away from the circuit board 50. The direction, in which the width dimension is increased, corresponds to a direction perpendicular to the moving direction of the operating member 7.

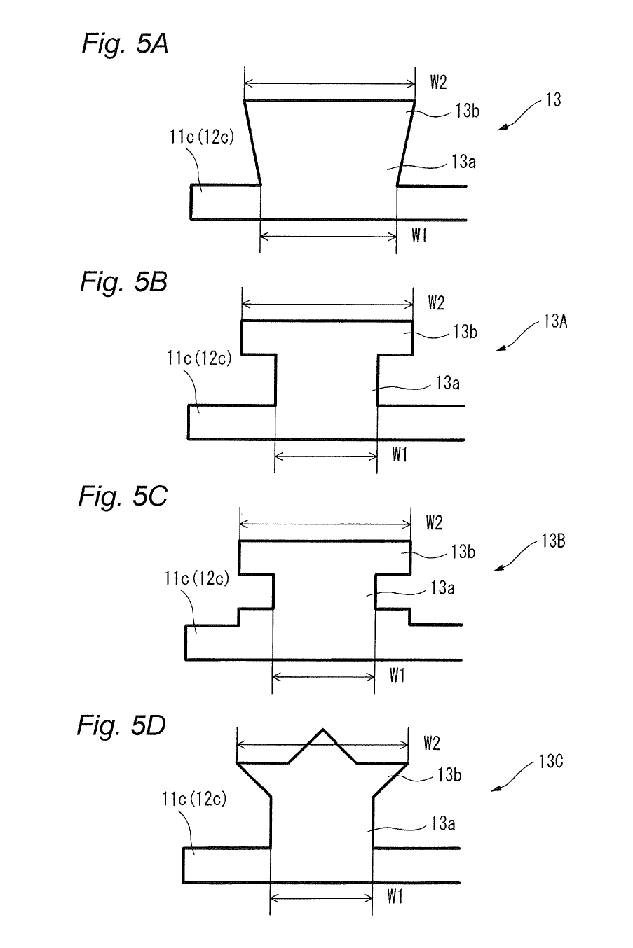

More particularly, as shown in FIG. 5A, each of the anchor members 13 includes a first anchor portion 13a having a first width dimension W1 and a second anchor portion 13b having a second width dimension W2 greater than the first width dimension W1. Because the first anchor portion 13a is located closer to the embedded portions 11c and 12c than the second anchor portion 13b is, it is possible to counter a stress in a direction separating a part of the case 2 from the conductive members.

The anchor members 13 are not limited to the above shape having inclined side end surfaces. If the second anchor portion 13b being wider in width than the first anchor portion 13a is located further away from the embedded portions 11c and 12c than the second anchor portion 13a is, a shape having stepped side end surfaces, as in an anchor member 13A shown in FIG. 5B, may also be conceived.

Also, if the second anchor portion 13b being wider in width than the first anchor portion 13a is located further away from the embedded portions 11c and 12c than the first anchor portion 13a is, a portion being wider in width than the first anchor portion 13a, as in an anchor member 13B shown in FIG. 5C, may be provided closer to the embedded portions 11c and 12c. Furthermore, a portion being narrower in width than the second anchor portion 13b, as in an anchor member 13C shown in FIG. 5D, may be provided on a side further away from the embedded portions 11c and 12c.

Each of the anchor members 13 is provided on sections of the embedded portions 11c and 12c of the conductive members extended parallel to the circuit board 50, in a state in which the push switch 1 is mounted on the circuit board 50. As a result, the preventing effect as described above can be more enhanced.

Also, the push switch 1 of the embodiment includes anchor members 14, as shown in FIG. 4A, which protrude from the electrode forming portion 12b of the conductive members 12 in a direction not parallel to a moving direction of the operating member 7 and are embedded into the wall portion defining the recess 2a of the case 2. The anchor members 14 can prevent a part of the case 2 from being detached from the conductive member, in particular by the component force in the direction parallel to the circuit board 50.

The second conductive member 12 has a plurality of anchor members 14. Each of the anchor members 14 protrudes obliquely downward from a side edge 12e of the electrode forming portion 12b. Each of the anchor members 14 forms an integral structure with the electrode forming portion 12b, and thus, together with the second conductive member 12, is easily formed by punching and bending a metal sheet.

As each of the anchor members 14 is further extended downward, in other words, further spaced away from the electrode forming portion 12b, a width dimension of the anchor member 14 is increased. This can more effectively prevent a part of the case 2 from being detached from the conductive member, in particular by the component force in the direction away from the circuit board 50. The direction, in which the width dimension is increased, corresponds to a direction perpendicular to the moving direction of the operating member 7.

Each of the anchor members 14 is not limited to the shape as shown in FIG. 4A, but variants described with reference to FIGS. 5A to 5D, like the anchor member 13, may also be conceived.

Each of anchor members 14 is provided on a section of the electrode forming portion 12b extended parallel to the circuit board 50, in a state in which the push switch 1 is mounted on the circuit board 50. As a result, the preventing effect as described above can be more enhanced.

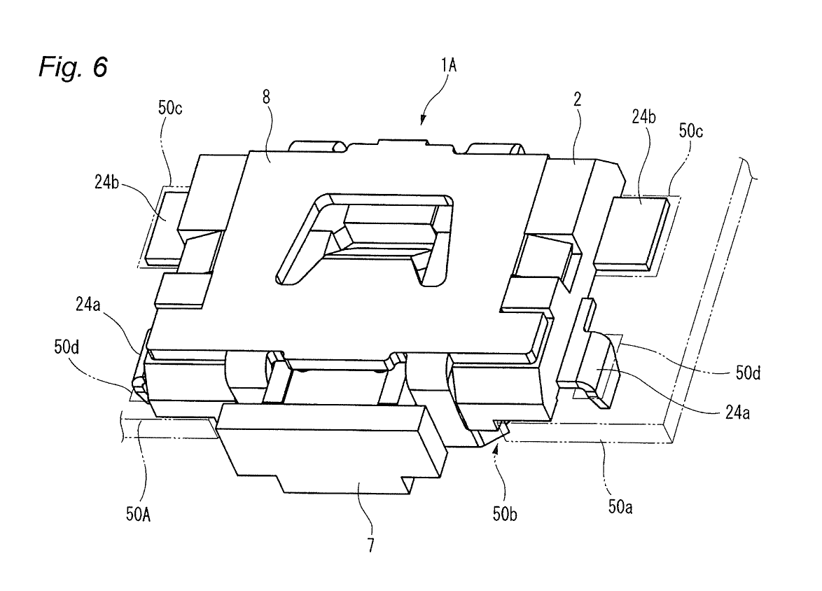

Hereinafter, a push switch 1A according to a variant of the embodiment will be described with reference to FIG. 6. This variant is different from the foregoing embodiment in a shape of outer connecting terminals. The other configurations are identical to those of the foregoing embodiment, and accordingly the detailed description thereof is omitted.

A first outer connecting terminal 24a electrically conductively connected with the first fixed electrodes 3a via the first conductive member 11 is exposed on each of the left and right side surfaces 2e and 2f of the case 2 to the outside, and then is bended downward. Each of the first outer connecting terminals 24a is inserted into a respective through-hole 50d connected to a wiring terminal formed on a mounting surface of a circuit board 50A and then is fixed by soldering.

A second outer connecting terminal 24b electrically conductively connected with the second fixed electrodes 3b via the first conductive member 12 is exposed on each of the left and right side surfaces 2e and 2f of the case 2 to the outside, and then is not bended, but extended parallel to the mounting surface of the circuit board 50A. Each of the second outer connecting terminals 24b is connected to a respective land potion 50c of a wiring terminal formed on the mounting surface by soldering.

Like the second outer connecting terminals 24b, the first outer connecting terminals 24a may be extended parallel to the mounting surface of the circuit board 50A and connected to the land portion 50c. Also, the second outer connecting terminals 24b, like the first outer connecting terminals 24a, may be bended downward and inserted into the through-hole 50d of the circuit board 50A.

The foregoing embodiments are intended to facilitate the understanding of the present invention, but not to limit the invention. The present invention may be modified and altered without departing from the spirit and scope of the invention, and is intended to encompass equivalents thereof.

If a switching between an electrically conductive state and an electrically non-conductive state is obtained by movement of the operating member 7, the number, shape and arrangement of the conductive members are properly determined depending on design requirements, but not limited to the above configuration. The number, shape, protruding direction and arrangement of the anchor members 13 and 14 are properly determined depending on such requirements in the conductive members.

For example, in the foregoing embodiments, a main surface (i.e., a surface having the larges area) of the anchor members 13 extends in a direction perpendicular to the moving direction of the operating member 7, and a main surface of the anchor members 14 extends in a direction parallel to the moving direction of the operating member 7. However, depending on the shape or arrangement of the conductive members, the directions, in which the anchor members 13 and 14 are extended, may be coincided with any one of the direction described above, and also may be obliquely transverse to the moving direction of the operating member 7.

Also, for example, the anchor members 13 and 14 in the embodiments are provided on sections of the conductive members extended parallel to the circuit board 50. However, depending on the shape or arrangement of the conductive members, the anchor members 13 and 14 may be provided on sections of the conductive members extended in a direction not parallel to the circuit board 50.

In the embodiments, the anchor members 14 are provided on only the electrode forming portion 12b of the second conductive member 12. However, the anchor member 14 may be provided on the electrode forming portion 11b of the first conductive member 11.

It is not necessary that the anchor members 13 and 14 form the integral structure with the conductive members. Anchor members, which are formed separately, may be fixed on the conductive member by welding or bonding.

It is not necessary that the anchor members 13 and 14 protrude from side edges of the conductive members. Depending on the shape or arrangement of the wall portion of the case 2, in which the anchor members are embedded, the anchor members may be provided on an upper or lower surface of the embedded portions 11c and 12c, or on a lower surface of the electrode forming portion 11b and 12b.

As shown in FIG. 2C, the portion 11f of the first conductive member 11 and the portion 12f of the second conductive member 12 in the embodiments are exposed on the board facing surface 2g of the case 2. The land portions 50c of the circuit board 50 may be provided at locations facing any one side of the exposed portions 11f and 12f, and the portions may be connected and fixed thereto by soldering.

When portions of the conductive members are exposed on a surface of the case 2 facing the circuit board 50, and the portions are connected to circuit wiring by soldering, outer connecting terminals exposed on side surfaces of the case 2 can be omitted, thereby decreasing a mounting area.

In the embodiments, the board inserting portion 2h is inserted into the notch 50b formed in the circuit board 50 and thus the push switch 1 is fixed on the circuit board 50. However, it is not necessary to provide the board inserting portion 2h. Namely, the board facing surface 2g of the case 2 may be substantially formed as the bottom surface of the case 2.

Also, in this case, each of the outer connecting terminals can employ the respective shape as described above, and in addition, the outer connecting terminals may be omitted such that portions of the conductive members exposed on a surface of the case 2 facing the circuit board may be connected to circuit wiring.

In the foregoing description, it will be understood that various directional terms with respect to ‘up and down,’ left and right,' and ‘front and rear’ are used only for convenience in the description with reference to the accompanying drawings, and that no fixed directional limitations in use of the product are intended by the use of these words. The terms “upward” and “downward” can be respectively changed to the terms ‘direction away from the circuit board’ and a ‘direction approaching to the circuit board.’ Similarly, the terms ‘front-rear direction’ and ‘left-right direction’ can be also changed to the term ‘direction parallel to the circuit board.’

In view of the above, according to the present invention, there can be prevented a part of the case from being detached from the conductive member, in particular by a component force in the direction parallel to the circuit board.

According the invention, there can be more effectively prevented a part of the case from being detached from the conductive member, in particular by a component force in the direction away from the circuit board.

According the invention, a structure of a high strength can be obtained by an easy processing, such as by punching a metal sheet.

Herein, the term ‘integral structure’ means that boundaries between the anchor member and the first and second portions are made of an identical material and boundaries therebetween are formed in a continuous state (i.e., a monolithic state). The term is used to be distinguished from a configuration in which two or more members different in material or properties are integrally connected to each other by welding or bonding.

If the anchor member protrudes from a side edge of at least one of the first portion and the second portions, the anchor member can be easily formed by formed by bending a metal sheet and the like.

When the anchor member are provided on a section of the conductive member extended parallel to the circuit board, in a state in which the push switch is mounted on the circuit board, the preventing effect as described above can be more enhanced.

According the invention, the third portion can be easily fixed on a mounting surface of the circuit surface by soldering and can be used as a connecting portion to circuit wiring.

When the third portion is used as a connecting portion to circuit wiring, a mounting area of the push switch can be decreased.

According to the present invention, there is provided a push switch which can satisfy demands for downsizing and also enhance durability against a pressing force of an operating member.

What is claimed is:

1. A push switch configured to be mounted on a circuit board, comprising:
an insulating case, having a wall portion defining a recess;
a conductive member, having a first portion embedded into the wall portion and a second portion disposed in the recess as a fixed electrode;
a movable electrode, disposed in the recess, and configured to be displaced between a first position in which the moveable electrode is contacted with the fixed electrode and a second position in which the movable electrode is spaced apart from the fixed electrode;
an operating member, configured to be moved in a direction parallel to the circuit board by a pressing force exerted thereon in a state in which the push switch is mounted on the circuit board, and to displace the movable electrode from the second position to the first position; and
an anchor member, protruding from the conductive member in a direction not parallel to the direction in which the operating member is moved, and embedded into the wall portion.

2. The push switch according to claim 1, wherein
the anchor member includes a first anchor portion having a first width dimension and a second anchor portion having a second width dimension greater than the first width dimension, and
the first anchor portion is located closer to the conductive member than the second anchor portion is.

3. The push switch according to claim 1, wherein
the anchor member forms an integral structure with the first portion.

4. The push switch according to claim 3, wherein
the anchor member protrudes from a side edge of the first portion.

5. The push switch according to claim 1, wherein
the anchor member forms an integral structure with the second portion.

6. The push switch according to claim 5, wherein the anchor member protrudes from a side edge of the second portion.

7. The push switch according to claim 1, wherein
the anchor member are provided on a section of the conductive member extended parallel to the circuit board in a state where the push switch is mounted on the circuit board.

8. The push switch according to claim 1, wherein
the conductive member comprises a third portion exposed on a side surface of the case.

9. The push switch according to claim 1, wherein
the conductive member comprises a third portion exposed on a surface of the case facing the circuit board.
